(19) United States
(12) Patent Application Publication
(10) Pub. No.: US 2013/0055690 A1
(43) Pub. Date: Mar. 7, 2013

(54) Enhanced air filtration mechanism

(71) Applicant: Kenneth Abbott, Tucson, AZ (US)

(72) Inventor: Kenneth Abbott, Tucson, AZ (US)

(73) Assignee: J & K MANAGEMENT INC.

(21) Appl. No.: 13/199,653

(22) Filed: Sep. 6, 2011

(51) Int. Cl. B01D 46/42

(52) U.S. Cl. 55/291; 55/383; 55/302

(57) ABSTRACT

A filtration system which uses a frame being a multi-sided tube positioned substantially horizontal. The tube is closed at a first end and supports a multitude of filters which filter the ambient air flowing into the interior of the multi-sided tube. A motor mechanism rotates the multi-sided tube around a horizontal axis while a fan draws air from the second end of said multi-sided tube, thereby pulling the ambient air through the filters. A pulsed air jet is directed at a bottom group of filters and periodically cleans the filters, allowing the debris to fall into a catch basin where an auger pulls the debris away.

### BACKGROUND OF THE INVENTION

This invention relates generally to filtration systems and more particularly to filtration systems used to remove air-borne particulates.

Air filtration continues to be an ever increasing problem. Manufacturing sites are generating more and more air-borne contaminates which must be removed from the workplace as well the environment in general. Tunneling operations generate an inordinate amount of dust and other airborne debris whose removal is critical for operation.

To address these applications, a number of solutions have been developed which utilize bag houses. Bag houses are specially designed buildings which contain a large number of filtering mechanisms. Dirty air is pumped or drawn through the filters to remove the airborne contaminates. Unfortunately, these bag houses require the construction of buildings and are difficult to clean or remove. Often the entire mining, manufacturing, or drilling operation must be shut down during the cleaning operation of the bag house.

To address the cleaning of the filters, the use of pulsed jets has been widely employed. The pulsed air jet periodically sends a high blast of air through the filter in the opposite direction of normal air flow to dislodge the collected debris so that the dislodged debris falls into a hopper where it can be removed.

All too often though, the systems that employ the pulsed jet are incapable of being “ganged” together to address the very large applications such as the tunneling example. As gangs of multiple air purifier units are created, the efficiency and portability of the ganged unit is diminished to such extent that often it is not feasible or effective to add more filtering units.

The overall effect is that air filters are often designed for the specific application, eliminating the ability to mass produce filter systems which can be grouped to meet the specific purpose. Without this economy of scale, the costs associated with air filtration on a large scale remain high.

It is clear there is a need for more effective and easier to operate filtration systems.

### SUMMARY OF THE INVENTION

The present invention creates a versatile air filtration system which allows the units to be efficiently “ganged” together to address a wide variety of application.

The individual units or cells is a filtration system which uses a frame being a multi-sided tube positioned substantially horizontal. In a single cell/unit embodiment, the tube is closed at a first end and has a multitude of filters extending outward.

In the preferred embodiment the tube is six sided but is not intended to be limited only to that configuration. In one embodiment the tube is hexagonal and in others the tube has a generally circular cross section.

Those of ordinary skill in the art readily recognize a variety of filters which are applicable to this application, including, but not limited to, U.S. Pat. No. 7,985,343, entitled “Modular Filter Assembly” issued Jul. 26, 2011, to Haldopoulos et al., U.S. Pat. No. 7,959,699, entitled “Collapsible Filter with Folding Arms” issued Jun. 14, 2011, to Privitt et al., and U.S. Pat. No. 7,981,187, entitled “Filter System Element Configuration; and Method” issued Jul. 19, 2011, to Gieseke et al., all of which are incorporated hereinto by reference.

The filters are used to clean the ambient air flowing from the “dirty” exterior into the “clean” interior of the multi-sided tube.

A motor mechanism rotates the multi-sided tube around a horizontal axis. The motor slowly rotates the multi-sided tube. Ideally the motor engages a gear affixed to one end of the tube or gang of tubes. The tube or gang of tubes are supported by a set of rollers while the motor rotates the assembly.

A fan draws air from the open end of said multi-sided tube, or gang, thereby pulling the ambient air through the filters. In some applications, the fan is powered by electricity although in certain applications, such as where the threat of explosion is present, the fan is pneumatically operated.

Fans are well known in the art and include such examples as those described in U.S. Pat. No. 4,255,080, entitled “Fans or the Like” issued Mar. 10, 1981, to Wilson et al., and U.S. Pat. No. 7,011,500, entitled “Rolling Barrel Fan” issued Mar. 14, 2006, to Matson, both of which are incorporated hereinto by reference.

The speed of the fan is typically in a set condition although in some embodiments, the speed of the fan is controlled by an operator to meet the demands of the situation.

Control of the fan is provided by any number of systems well known to those of ordinary skill in the art, including, but not limited to: U.S. Pat. No. 7,953,520, entitled “Cooling Fan Controlling Revolving Fan Based Fluid Temperature and Air Temperature” issued May 31, 2011, to Hayashi, incorporated hereinto by reference.

As the tube or gang of tubes is rotated, each of the tube's faces with attendant filters passes across the bottom most position. In this situation, a pulsed air jet is directed at a bottom group of filters. The pulsed jet dislodges the collected debris and as such cleans the filters. This allows the debris to fall into a catch basin where an auger pulls the debris away.

In this manner, the filters are periodically cleaned so that their maximum efficiency is maintained as the tube or gang of tubes continues in its rotation.

The invention, together with various embodiments thereof will be more fully explained by the accompanying drawings and the following description thereof.

### DRAWINGS IN BRIEF

FIG. 1 is a perspective view of the preferred embodiment of the invention.

FIG. 2 is a top view of the preferred embodiment without the surrounding plenum and the filters removed for illustrative purposes.

FIG. 3 is a perspective view of the preferred embodiment arranged in a gang relationship.

FIG. 4 illustrates the flow of air through the invention.

FIG. 5 illustrates the cleaning of the filters and the removal of the debris therefrom.

### DRAWINGS IN DETAIL

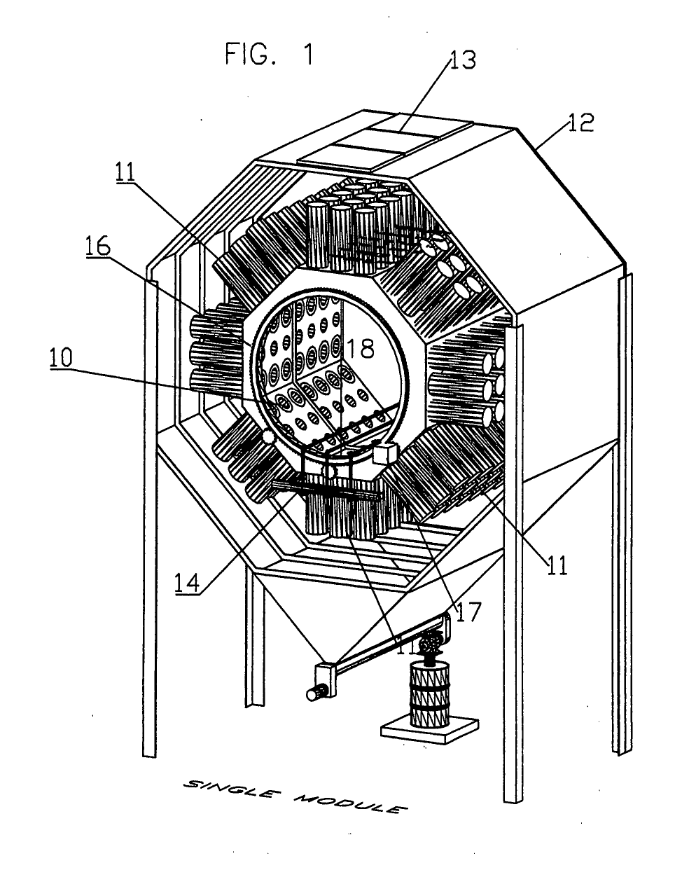

FIG. 1 is a perspective view of the preferred embodiment of the invention.

In this illustration the multi-sided tube 10 has eight sides but those of ordinary skill in the art recognize that the invention is not so limited and can have a minimum of three sides and is not limit as to the maximum number of sides.

Tube 10 has secured thereto a multitude of filters 11. Filters 11 are chosen to clean the “dirty” air within plenum 12 to the level desired for the specific application as the dirty air is pulled through filters 11. Once the “dirty” air passes through filters 11, the air within tube 10 is “clean” and can be used as desired.

In this embodiment, at the top of dirty air plenum 12 are openings 13 which have doors (not shown) to seal the dirty air plenum 12. Openings 13 are used for access to the filters 11 at the upper-most face of the multi-sided tube 10. The upper-most filters can be easily replaced through openings 13. Although this embodiment illustrates openings 13 at the top of plenum 12, alternative embodiments use openings on any of the sides of plenum 12 for this purpose.

One end of tube 10 is sealed 18 allowing a fan (not shown) positioned at the open end of tube 10 to pull air from the dirty air plenum 12 position through filters 11 into the interior of tube 10; thereby cleaning the air and creating a flow of clean air.

Tube 10 is rotated using geared motor 17 which engages geared collar 16 attached to tube 10.

Geared motor 17 rotates tube 10 with its attendant filters 11 via geared collar 16 so that at all filters are sequentially placed at a bottom position 11A. During this time, filters 11A are subjected to a reversed pulsed jet mechanism 14 which communicates with all of filters 11A via tubing 15. The pulsed jet so created, causes the debris which has been collected by filters 11A to be ejected from filters 11A and fall into a catch basin (not shown). In this manner, the filters are periodically cleaned so that the efficiency of the mechanism is maintained.

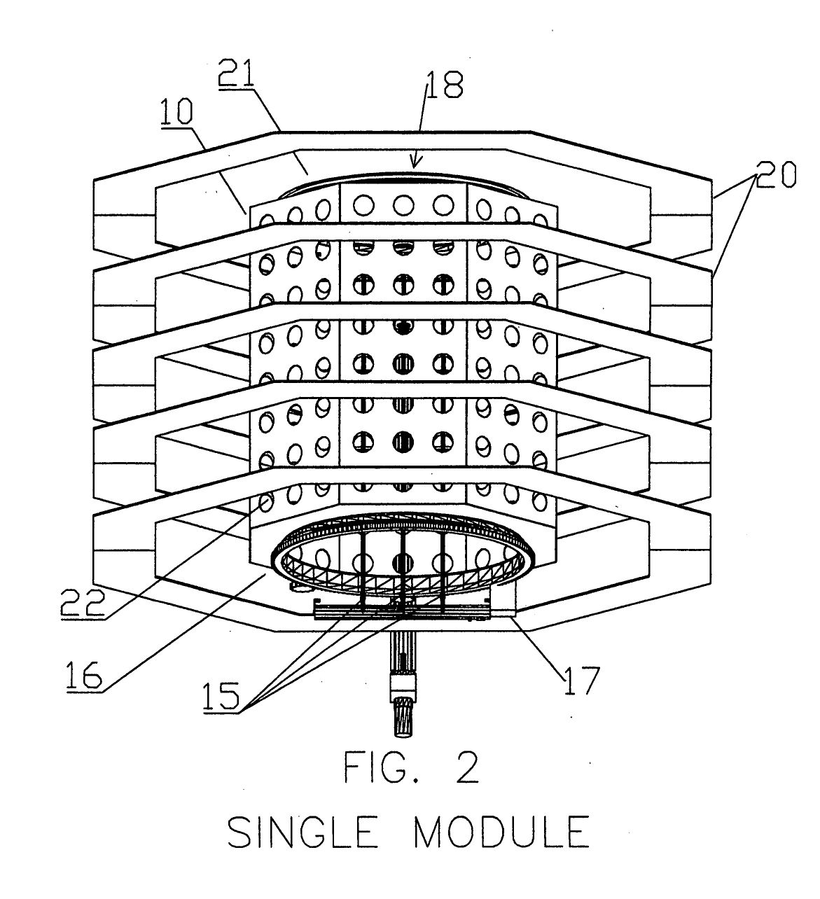

FIG. 2 is a top view of the preferred embodiment without the surrounding plenum and the filters removed for illustrative purposes.

In this illustration, the dirty air plenum is illustrated by ribbing 20 which encircles tube 10. As discussed earlier, one end of tube 10 is sealed 18. Holes 22 allows the filters (not shown in this illustration) to be secured to tube 10 and to allow air to pass therethrough during operation of the system.

Tube 10 is rotated using geared motor 17 which engages the geared collar 16 which is secured to tube 10. While this embodiment places the geared collar 16 and the geared motor 17 at the open end of tube 10, an alternative embodiment places the geared collar and the geared motor at the closed end 18.

Tubing 15 is used to communicate the pulsed jet of cleaning air to the appropriate filters.

At the opposing end from geared collar 16 is a roller mechanism 21 which supports the distal end of tube 10, thereby allowing tube 10 to be easily rotated by geared motor 17.

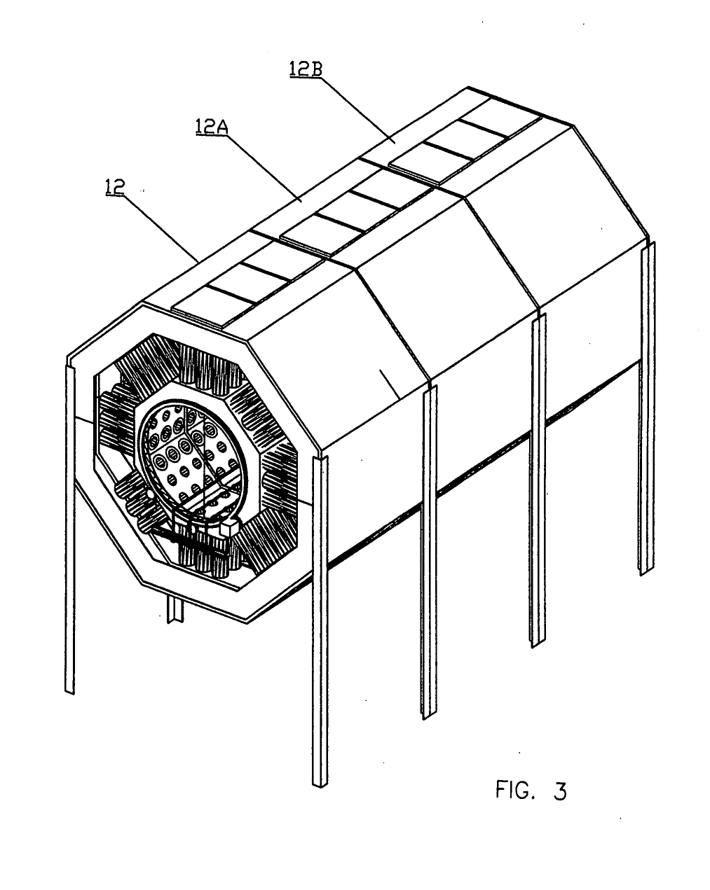

FIG. 3 is a perspective view of the preferred embodiment arranged in a gang relationship.

Because of the invention's overall design, the basic units can be easily placed in a gang relationship allowing any number of units to be joined in a linear relationship 12, 12A, and 12B as shown. Although the present invention shows three units, any number may be so joined.

In this type of situation, only the most distal end (on unit 12B in this illustration) is closed allowing the interior of the different units to be addressed with a single fan (not shown).

In this fashion, a single “cell” or unit is created and then combined with other “cells” or units to address the specific application. As example, a manufacturing site may require only a single unit while a mining or tunnel boring application might require five or six units.

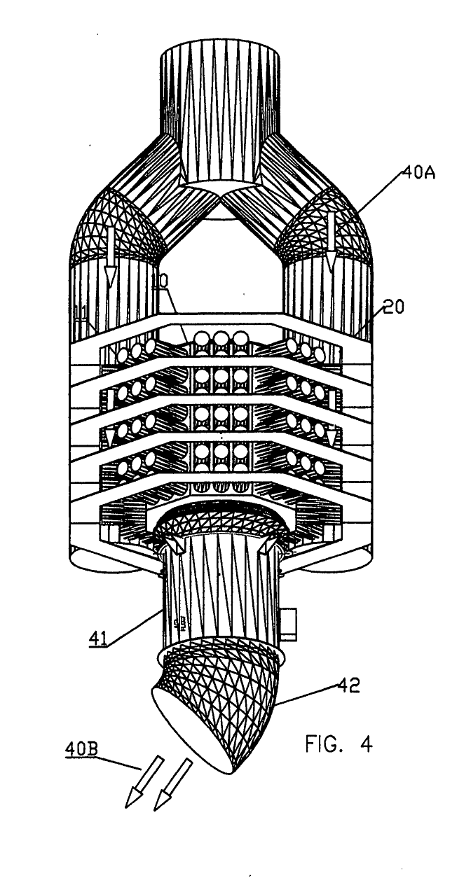

FIG. 4 illustrates the flow of air through the invention.

Dirty air flows as illustrated by arrows 40A into plenum 20 and through holes 20 into the interior of tube 10 as drawn by fan 41. The dirty air, after flowing through the filters (not shown) is “clean” and is directed by fan 41 into ducting 42 so that clean air 40B is passed to the desired location.

In some situations clean air 40B is directed back into the workplace while other applications call for the clean air to be exhausted into the environment. This latter application is used to clean an air-flow to eliminate environmental effects from contaminates being collected on the filters.

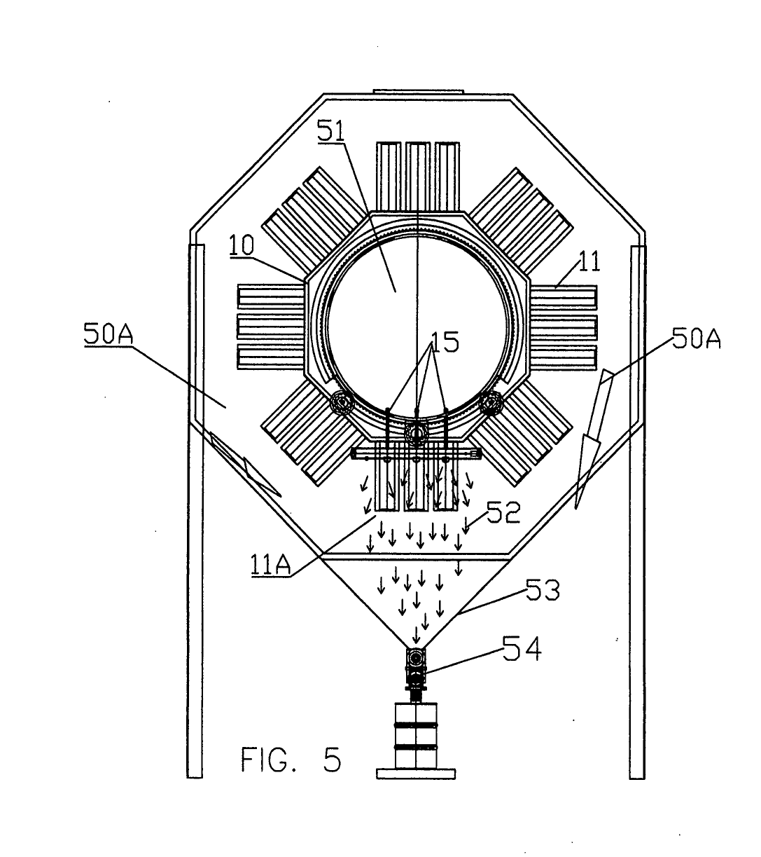

FIG. 5 illustrates the cleaning of the filters and the removal of the debris therefrom.

Tube 10 includes filters 11 as described above and is rotated around a central axis. Dirty air 50A is pulled through filters 11 into an interior of 51 of tube 10.

When the filters on a face of the tube are in the bottom position during the rotation of tube 10, as illustrated by filters 11A, tubes 15 communicate a reversed pulsed jet into filters 11A, forcing debris 52 to fall therefrom. Debris 52 is collected by hopper 53 which communicates debris 52 to auger 54 which pulls debris 52 to a waste disposal location (not shown).

In this manner, filters 11A are cleaned, the dislodged debris 52 is properly discharged, and the mechanism continues in its rotation using now cleaned filters.

The present invention creates an effective and easily operational filtration system.

What is claimed is:

1. A filtration system comprising:
a) a multi-sided tube positioned substantially horizontal, said tube being closed at a first end thereof and having a multitude of filters attached thereto communicating between an ambient exterior and an interior of the multi-sided tube;
b) a motor mechanism connected to said multi-sided tube configured to rotate said multi-sided tube around a horizontal axis;
c) a fan drawing air from the second end of said multi-sided tube such that ambient air is drawn into an interior of said multi-sided tube via the multitude of filters; and,
d) a pulsed air jet directed at a bottom portion of said multi-sided tube, said pulsed air jet being periodically activated to emit an air jet from the interior of the multi-sided tube through filters located at the bottom of the multi-sided tube.

2. The filtration system according to claim 1,
a) wherein said motor mechanism further includes a driving gear; and
b) further including a gear collar secured to said multi-sided tube, said geared collar configured to accept the driving gear from said motor mechanism.

3. The filtration system according to claim 2, further including a roller mechanism supporting the first end of the multi-sided tube.

4. The filtration system according to claim 3, further including a clean air plenum positioned to accept air from said fan and directing air therefrom into an air exhaust system.

5. The filtration system according to claim 4, further including a dirty air plenum positioned to direct ambient air to an exterior of said multi-sided tube.

6. The filtration system according to claim 5, wherein said dirty air plenum includes a door positioned at an upper most aspect, said door, when open, exposing the filters at an upper most position of said multi-sided tube.

7. The filtration system according to claim 5, further including:
a) an exhaust hopper positioned proximate to the bottom of the multi-sided tube, said exhaust hopper collecting debris from filters thereabove; and,
b) an auger positioned to remove debris from the exhaust hopper.

8. An expandable filtration assembly comprising:
a) At least two multi-sided tubes positioned substantially horizontal and connected end to end to form an extended tube, each of said tubes having a multitude of filters attached thereto communicating between an ambient exterior and an interior of the multi-sided tube, a first end of the extended tube being closed at a first end thereof;
b) a motor mechanism connected to said extended tube and configured to rotate said multi-sided tube around a horizontal axis;
c) a fan drawing air from an interior of the extended tube multi-sided tube such that ambient air is drawn into an interior of said extended tube via the multitude of filters; and,
d) a pulsed air jet directed at a bottom portion of said extended tube, said pulsed air jet being periodically activated to emit an air jet from the interior of the extended tube through filters located at the bottom of the extended tube.

9. The expandable filtration assembly according to claim 8,
a) wherein said motor mechanism further includes a driving gear; and
b) further including a gear collar secured to said extended tube, said geared collar configured to accept the driving gear from said motor mechanism.

10. The expandable filtration assembly according to claim 9, further including a roller mechanism supporting the extended tube.

11. The expandable filtration assembly according to claim 10, further including a clean air plenum positioned to accept air from said fan and directing air therefrom into an air exhaust system.

12. The expandable filtration assembly according to claim 11, further including a dirty air plenum positioned to direct ambient air to an exterior of said multi-sided tube.

13. The expandable filtration assembly according to claim 12, wherein said dirty air plenum includes a door positioned at an upper most aspect, said door, when open, exposing at least one of the filters at an upper most position of said multi-sided tube.

14. The expandable filtration assembly according to claim 13, further including:
a) an exhaust hopper positioned proximate to the bottom of the multi-sided tube, said exhaust hopper collecting debris from filters thereabove; and,
b) an auger positioned to remove debris from the exhaust hopper.

15. A filtration system comprising:
a) a hexagonal tube positioned substantially horizontal, said hexagonal tube being closed at a first end thereof and having a multitude of filters attached thereto, said multitude of filters communicating between an ambient exterior and an interior of the hexagonal tube;
b) a motor mechanism connected to said hexagonal tube configured to rotate said hexagonal tube around a horizontal axis;
c) a fan drawing air from a second end of said hexagonal tube such that ambient air is drawn into an interior of said hexagonal tube via the multitude of filters.

16. The filtration system according to claim 15, further including:
a) a pulsed air jet directed at a bottom portion of said hexagonal tube, said pulsed air jet being periodically activated to emit an air jet from the interior of the multi-sided tube through filters located at a bottom of the hexagonal tube;
b) an exhaust hopper positioned proximate to the bottom of the hexagonal tube, said exhaust hopper collecting debris from filters thereabove; and,
c) an auger positioned to remove debris from the exhaust hopper.

17. The filtration system according to claim 15,
a) wherein said motor mechanism further includes a driving gear; and
b) further including a gear collar secured to said multi-sided tube, said geared collar configured to accept the driving gear from said motor mechanism.

18. The filtration system according to claim 17, further including a roller mechanism supporting the first end of the hexagonal tube.

19. The filtration system according to claim 18, further including:
a) a clean air plenum positioned to accept air from said fan and directing air therefrom into an air exhaust system; and,
b) a dirty air plenum positioned to direct ambient air to an exterior of said filters.

20. The filtration system according to claim 19, wherein said dirty air plenum includes a door positioned at an upper most aspect, said door, when open, exposing at least one filter at an upper most face of said multi-sided tube.
